(19) United States
(12) Patent Application Publication
(10) Pub. No.: US 2008/0183481 A1
(43) Pub. Date: Jul. 31, 2008

(54) SERVICE PROVIDER SERVER, SERVICE PROVIDING METHOD AND RECORDING MEDIUM RECORDED WITH SERVICE PROVIDING PROGRAM

(75) Inventor: Naoki Kazagoshi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/964,391

(22) Filed: Dec. 26, 2007

(30) Foreign Application Priority Data
Jan. 25, 2007 (JP) JP2007-015036

(51) Int. Cl. G06Q 30/00

(52) U.S. Cl. 705/1

(57) ABSTRACT

A service provider server 1, when receiving a charge-free service providing request, inquires about existence or non-existence of data coincident with credit card number data sent from a client, with which the charge-free service providing request accompanies, and, if a predetermined condition is satisfied, provides the charge-free service.

This application claims the benefit of Japanese Patent Application No. JP2007-015036 filed on Jan. 25, 2007 in the Japanese Patent Office, the disclosure of which is herein incorporated in its entirety by reference.

### BACKGROUND OF THE INVENTION

The present disclosure relates to a service provider server, a service providing method and a recording medium recorded with a service providing program.

With widespread of the Internet, services are actively provided via communication networks (refer to, e.g., Patent document 1). Further, for promoting sales of fee-charging services, charge-free benefit services such as [Trial charge-free campaign for three months after entrance] are incessantly conducted.

[Patent document 1] Japanese Patent Application Laid-Open Publication No. 2002-259791

### SUMMARY OF THE INVENTION

Providing a fee-charging service via a communication network involves conducting a credit reference etc to individual information when performing an electronic settlement, and it is therefore comparatively difficult to have a transaction in the way of pretending another person. On the other hand, a variety of charge-free benefit services provided via the communication network do not involve conducting the credit reference based on the electronic settlement when providing the benefit services, and hence it is possible for a user pretending another person to be provided with the service.

Many types of services are provided, wherein mail addresses used comparatively often for specifying the individuals can be obtained on a charge-free basis. Accordingly, for example, a user gets membership during a trial period of a service with a benefit, then pretends another person by changing the mail address etc each time the charge-free service period expires, and can be again provided with the charge-free benefit service. If this manipulation repeats, it follows that service providers might suffer a tremendous damage.

Such being the case, it is an object of the present disclosure to provide a service provider server, a service providing method and a recording medium recorded with a service providing program, which properly allocate benefits to clients.

According to the present disclosure, in order to solve the problems given above, a charge-free service is provided if a predetermined condition is satisfied after inquiring, when receiving a charge-free service providing request, about existence or non-existence of data coincident with credit card number data transmitted from the client, with which the charge-free service providing request accompanies.

To be more specifically, a service provider server comprises: a service providing unit providing a service to a client via a communication network; a condition setting storage unit having a setting of a predetermined condition required to be satisfied when the client is provided with a charge-free service; a card number storage unit stored with credit card number data transmitted from the client via the communication network; and a service history storage unit stored with a history of the charge-free service provided to the client, wherein the service providing unit, when receiving a fee-charging service providing request from the client, transmits the credit card number data transmitted from the client, with which the fee-charging service providing request accompanies, to a credit reference system and, when receiving a result of approval from the credit reference system, provides the fee-charging service and stores the credit card number data in the card number storage unit, the service providing unit, when receiving a charge-free service providing request from the client, searches the card number storage unit for existence or non-existence of data coincident with the credit card number data transmitted from the client, with which the charge-free service providing request accompanies, and further searches the service history storage unit for existence or non-existence of a history of the charge-free service provided to the client, and the service providing unit, if the charge-free service providing request of the client satisfies the predetermined condition, provides the charge-free service and stores a charge-free service providing history in the service history storage unit.

The service provider server according to the present disclosure focuses on a point that the credit card number is issued after undergoing a credit search of the individual. Namely, for example, if in the case of the mail address, the mail address can be acquired without undergoing the credit search, and hence the same person can easily pretend another person. On the other hand, if in the case of the credit card number, the card number is issued after via the credit search, and it is therefore difficult for the same person to pretend another person. Hence, on the occasion of providing the charge-free service via the communication network, it is feasible to prevent the charge-free service from being dually provided to the same spoofing client pretending by specifying the client with the credit card number.

Such being the case, the service provider server according to the present disclosure comprises the service providing unit, the condition setting storage unit, the card number storage unit and the service history storage unit.

The service providing unit co-operates with the condition setting storage unit, the card number storage unit and the service history storage unit, and thus provides the service to the client via the communication network.

The condition setting storage unit has a setting of a predetermined condition set beforehand by a service provider and required to be satisfied when the client is provided with the charge-free service.

The card number storage unit is stored with the credit card number data transmitted via the communication network from the client.

The service history storage unit is stored with a databased history of providing the charge-free service to the client.

The service providing unit, when receiving a fee-charging service providing request from the client, transmits, to a credit reference system of the credit card, the credit card number data transmitted from the client, with which the fee-charging service providing request accompanies. Then, the service providing unit, when the credit card number data is approved by the credit reference system and when receiving a result of the approval purporting the approval being made by the credit reference system, provides the fee-charging service to the client. The fee-charging service to be provided may, if being an electronic service provided via the communication network, have any categories of contents. On the occasion of carrying out the credit reference, considerable methods are a method of connecting the service provider server according to the present disclosure to a computer of the credit reference system via a communication line and electronically carrying out the credit reference by transmitting the credit card number data, and a method by which an operator of the credit reference system checks the credit card number data transmitted from the service provider server and transmits a result of the approval purporting that the credit card number data has been approved to the service provider server. Note that the credit card number data is data containing items of information such as the credit card number and its expiration date transmitted from the client and is also data used for the electronic settlement when the client purchases, e.g., a fee-charging service.

The credit card number data undergoes the credit reference in the credit reference system, thereby confirming the credibility of the credit card number and confirming the identity of the user who uses the credit card number.

The service providing unit, when receiving the charge-free service providing request from the client, searches the card number storage unit for existence or non-existence of data coincident with the credit card number data transmitted from the client, with which the charge-free service providing request accompanies. Further, the service providing unit searches the service history storage unit for existence or non-existence of a history of providing the charge-free service to the client in the past. Then, the service providing unit, if the predetermined condition was satisfied, provides the charge-free service and stores the charge-free service providing history in the service history storage unit. The inquiry of the user's identity involves using the credit card number data for the credit reference, and hence, even if the user pretends another person by acquiring a plurality of IDs and tries to be provided with the same charge-free service dually, it is possible to confirm that the client is the same person.

It should be noted that the predetermined condition is a condition required to be satisfied when the client is provided with the charge-free service, and is exemplified by, e.g., an upper limit value etc of a charge-free service providing count by which the same client can be provided with the charge-free service. The service provider server, unless the charge-free service providing count of the charge-free service provided to the same client exceeds the upper limit value, provides the charge-free service.

From what has been described so far, the service provider server according to the present disclosure is capable of properly allocating the benefit to the client.

Further, the predetermined condition may be a condition that the charge-free service is not provided if data coincident with the credit card number data transmitted from the client, with which the charge-free service providing request accompanies, is retrieved by searching the card number storage unit and if the history of providing the charge-free service to the client is retrieved by searching the service history storage unit.

The service history storage unit is stored with the data coincident with the credit card number transmitted from the client with which the charge-free service providing request accompanies, the implication being that the client was provided with the service from the service provider server in the past. Moreover, if the client using the same credit card number as the credit card number retrieved by the card number storage unit was provided with the charge-free service in the past and if the providing history thereof is stored in the service history storage unit, this history is to be retrieved. With this scheme, even when the same user pretending another person by use of a different ID etc requests the charge-free service to be provided, the inquiry about the identity is made based on the credit card number data, and it is therefore feasible to prevent the same user from being provided with the charge-free service dually.

Still further, the present disclosure can be grasped from an aspect of a method. Namely, a service providing method is a method for providing a service provided by a service provider server comprising: a service providing unit providing a service to a client via a communication network; a condition setting storage unit having a setting of a predetermined condition required to be satisfied when the client is provided with a charge-free service; a card number storage unit stored with credit card number data transmitted from the client via the communication network; and a service history storage unit stored with a history of the charge-free service provided to the client, wherein the service providing unit, when receiving a fee-charging service providing request from the client, transmits the credit card number data transmitted from the client, with which the fee-charging service providing request accompanies, to a credit reference system and, when receiving a result of approval from the credit reference system, provides the fee-charging service and stores the credit card number data in the card number storage unit, the service providing unit, when receiving a charge-free service providing request from the client, searches the card number storage unit for existence or non-existence of data coincident with the credit card number data transmitted from the client, with which the charge-free service providing request accompanies, and further searches the service history storage unit for existence or non-existence of a history of the charge-free service provided to the client, and the service providing unit, if the charge-free service providing request of the client satisfies the predetermined condition, provides the charge-free service and stores a charge-free service providing history in the service history storage unit.

Yet further, the present disclosure can be grasped from an aspect of a program. Namely, a recording medium is recorded with a service providing program for making a service provider server provide a service, the server comprising: a service providing unit providing a service to a client via a communication network; a condition setting storage unit having a setting of a predetermined condition required to be satisfied when the client is provided with a charge-free service; a card number storage unit stored with credit card number data transmitted from the client via the communication network; and a service history storage unit stored with a history of the charge-free service provided to the client, wherein the service provider server makes the service providing unit execute, when receiving a fee-charging service providing request from the client, transmitting the credit card number data transmitted from the client, with which the fee-charging service providing request accompanies, to a credit reference system and, when receiving a result of approval from the credit reference system, providing the fee-charging service and storing the credit card number data in the card number storage unit, the service provider server makes the service providing unit execute, when receiving a charge-free service providing request from the client, searching the card number storage unit for existence or non-existence of data coincident with the credit card number data transmitted from the client, with which the charge-free service providing request accompanies, and further searching the service history storage unit for existence or non-existence of a history of the charge-free service provided to the client, and the service provider server makes the service providing unit execute, if the charge-free service providing request of the client satisfies the predetermined condition, providing the charge-free service and storing a charge-free service providing history in the service history storage unit.

According to the present disclosure, it is possible to provide the service provider server, the service providing method and the recording medium recorded with the service providing program, which properly allocate benefits to clients.

### BRIEF DESCRIPTION OF THE DRAWINGS

FIG. 1 is a view of a whole architecture, showing one usage mode of a service provider server according to an embodiment;

FIG. 2 is a flowchart of processing contents of the service provider server according to the embodiment;

FIG. 3 is a flowchart of processing contents of the service provider server according to the embodiment.

### DETAILED DESCRIPTION OF THE INVENTION

An embodiment of the present disclosure will herein after be described in an exemplified manner. A configuration in the following embodiment is an exemplification, and the present disclosure is not limited to the configuration in the embodiment.

<Architecture>

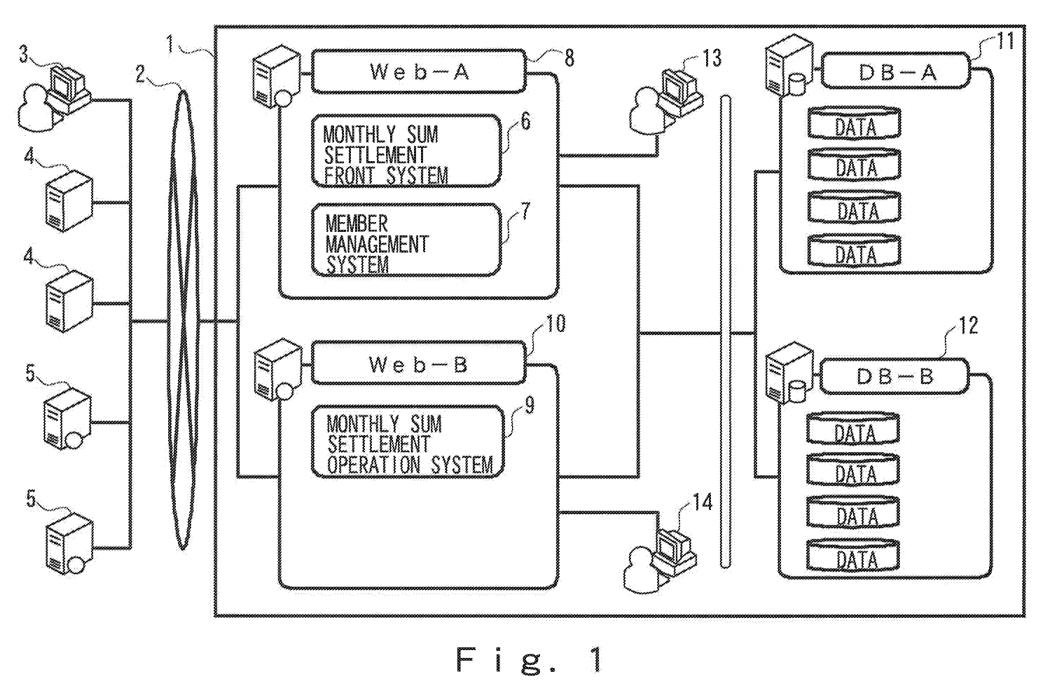

FIG. 1 is a view of a whole architecture, showing a service provider server 1 according to the present embodiment, and clients 3, service providing systems 4 and credit reference systems 5, which are connected via a communication network 2 to the service provider server 1.

As illustrated in FIG. 1, the service provider server 1 according to the present embodiment includes a Web-A8 (e.g., AzbyClub (registered trademark) Web etc administered by Fujitsu Co., Ltd.) having a monthly sum settlement front system 6 and a member management system 7, and a Web-B10 (e.g., WebMart (registered trademark) etc administered by Fujitsu Co., Ltd.) having a monthly sum settlement operation system 9. Note that the service provider server 1 further includes a database DB-A11 and a database DB-B12 for storing necessary items of data for operating the Web-A8 system and the Web-B10 system. The service provider server 1 is constructed of a CPU, a memory, input/output interfaces, a hard disk storage device, etc, wherein the CPU executes a computer program, and hardware resources co-operate with each other, thereby realizing a variety of functions of the Web-A8, the Web-B10, the DB-A11 and the DB-B12.

The discussion starts with explaining the Web-A8, the Web-B10, the DB-A11 and the DB-B12 that buildup the service provider server 1.

The Web-A8 includes the monthly sum settlement front system 6 and the member management system 7. The Web-A8 is configured to enable intercommunications with the DB-A11, the DB-B12, the clients 3, the service providing systems 4 and the credit reference systems 5 via the communication network 2 connected to the outside and the input/output interfaces. Note that the Web-A8 deals with individual information such as credit card numbers of the clients 3, a firewall etc is therefore installed on the communication line, and proper encryption is thus conducted on the occasion of performing the communications, thereby assuring information security. It is to be noted that the Web-A8 is configured to enable an operator 13 to carry out maintenance work.

The monthly sum settlement front system 6 takes charge of acceptance work for applications and cancellations of contract of a monthly payment system service (such as providing antivirus software provided by the service providing systems 4) from the clients 3. Namely, the monthly sum settlement front system 6, when having an access from the client 3 via the communication network 2 (such as the Internet), displays on a display of the client 3 a list screen, an application screen, a cancellation-of-contract procedure screen, etc of the monthly payment system service, which can be provided by the service provider server 1. The client 3 inputs desired items of information onto the list screen, the application screen, the cancellation-of-contract procedure screen, etc, which are displayed on the display, and transmits these desired items of information to the monthly sum settlement front system 6, thereby making requests for the applications for and the cancellations of contract of a variety of monthly payment system services. Further, the monthly sum settlement front system 6 stores pieces of information on contents of the applications and contents of the cancellations of contract of the monthly payment system service in the DB-A11 and the DB-B12 as the necessity may arise.

The monthly sum settlement front system 6 receiving the requests for the application and the cancellation of contract of the monthly payment system service from the client 3 transfers these desired items of information transmitted from the client 3 to the member management system 7.

The member management system 7 manages information on users of which memberships are registered in the service provided by the service provider server 1. Namely, the member management system 7, when accessed from the client 3 via the communication network 2, displays an operation screen for demanding inputs of a login ID, a password, etc and for accepting requests for newly inputting, changing and deleting member information such as a name, an address, a telephone number, a date of birth, a mail address, a company to which the member belongs, and a number and an expiration date of a credit card, and also displays pieces of information such as a usage record of the service used by the user and an accounting status.

Moreover, the member management system 7 (corresponding to [service providing means] according to the present disclosure) mutually exchanges the data with the monthly sum settlement front system 6, the monthly sum settlement operation system 9, the DB-A11 and the DB-B12. To be specific, the member management system 7 transfers and saves the member information sent from the client 3 to and in the DB-A11, then collates pieces of application information of a variety of services that are transmitted from the monthly sum settlement front system 6 with the credit card numbers stored in the DB-A11, and transmits the credit card numbers to the credit reference systems 5 of the credit cards via the communication network 2, thus performing the electronic settlement. Further, the member management system 7, when acquiring an electronic approval from the credit reference system 5, provides the service requested by the client 3 to be provided and causes the service providing system 4 to provide the client 3 with the service.

The Web-B10 includes the monthly sum settlement operation system 9. The Web-B10 is, in the same way as the Web-A8 is, configured to enable the intercommunications with the DB-A11, the DB-B12, the clients 3, the service providing systems 4 and the credit reference systems 5 via the communication network 2 connected to the outside and the input/output interfaces. Further, the Web-B10 is, in the same way as the Web-A8 is, assured of the information security through the encrypted communications. Note that the Web-B10 is configured to enable an operator 14 to carry out the maintenance work.

The monthly sum settlement operation system 9 sends commercial article information defined as information about contents and charges of the services (commercial articles) to be provided, a providing period of a charge-free campaign, conditions for providing target members, etc, and issues bills occurred from the electronic settlements using the credit cards. Furthermore, the monthly sum settlement operation system 9 accepts inputs of commands necessary for the operation of the service provider server 1 such as stopping the services and cancelling the contracts of the services via the operator. Note that the monthly sum settlement operation system 9 saves the commercial article information, sales figures, the bill data, etc in the DB-B12 and refers to the DB-B12 according to the necessity.

The DB-A11 and the DB-B12 (corresponding to [a card number storage unit], [a service history storage unit] and [a condition setting storage unit] according to the present disclosure) are constructed of hard disk storage devices, input/output interfaces, etc, and are stored with databased items of information such as information about benefit points, names, addresses, user IDs of the members, information about the contents and the histories of the provided services, contents of the monthly payment system services, membership fees, credit card numbers of the users, and an upper limit value of charge-free service providing count for the same client. Note that the DB-A11 and the DB-B12 periodically back up the data in preparation against unexpected failures of the hard disk storage devices etc, and save the data in optical discs etc. Moreover, the DB-A11 and the DB-B12 are configured, for assuring confidentiality of the recorded data, so that the data can be neither browsed nor altered without via the specified ID and password.

Next, the client 3 will be described. The client 3 is a so-called personal computer constructed of a CPU, a memory, input/output interfaces, a hard disk recording device, etc. The user starts up a WWW Browser (World-Wide-Web Browser) preinstalled in the client 3, and accesses the Web-A8 and the Web-B10, thereby making the application for and canceling the contract of the service provided by the service provider server 1 and being provided with the variety of services such as receiving distribution of the antivirus software and an updated virus definition file. It should be noted that the client 3 may be, though constructed of the personal computer in the present embodiment, sufficient if capable of accessing the service provider server 1 via the communication network 2 and may also be, e.g., a mobile phone, a PDA (Personal Digital Assistant), etc.

Next, the service providing system 4 will be explained. The service providing system 4 is a server computer constructed of a CPU, a storage device, etc and provides the service through the communications via the communication network 2. Namely, the service providing system 4, upon receiving the request from the service provider server 1, provides the service to the client 3 via the communication network 2. The service providing system 4, when receiving a request saying, e.g., [A service C is to be provided to a client D in a period A through a period B.] from the service provider server 1, provides the service conforming to this request. Note that the service providing system 4 is not limited to the single system and may take such a mode that a plurality of systems provides a multiple services to each other. The service providing system 4 provides a security service based on the monthly sum system and the variety of services such as distributing video contents, music contents, etc. The service providing system 4, which provides the security service, is exemplified by service provider servers administered by, e.g., Symantec Corp. and TRENDMICRO Corp.

Subsequently, the credit reference system 5 will be described. The credit reference system 5 is a server computer constructed of a CPU, a storage device, etc and executes an electronic settlement process through the communications via the communication network 2. To be specific, the credit reference system 5 collates the electronic settlement information (e.g., a name and a price of the purchased commercial article, and the expiration date and a personal identification number of the credit card) transmitted from the service provider server 1 with customer information (e.g., a name and an address of the customer, and a maximum available amount and a maximum loan amount of the credit card) accumulated in the credit reference system 5 itself. The credit reference system 5, if the electronic settlement information transmitted from the service provider server 1 is coincident with the customer information accumulated in the self-system 5 and meets an approval standard for the electronic settlement, transmits information purporting the approval of the electronic settlement to the service provider server 1. The credit reference system 5 is exemplified by, e.g., credit reference servers administered by VISA Corp. and Master Card Corp.

<Processing Flow>

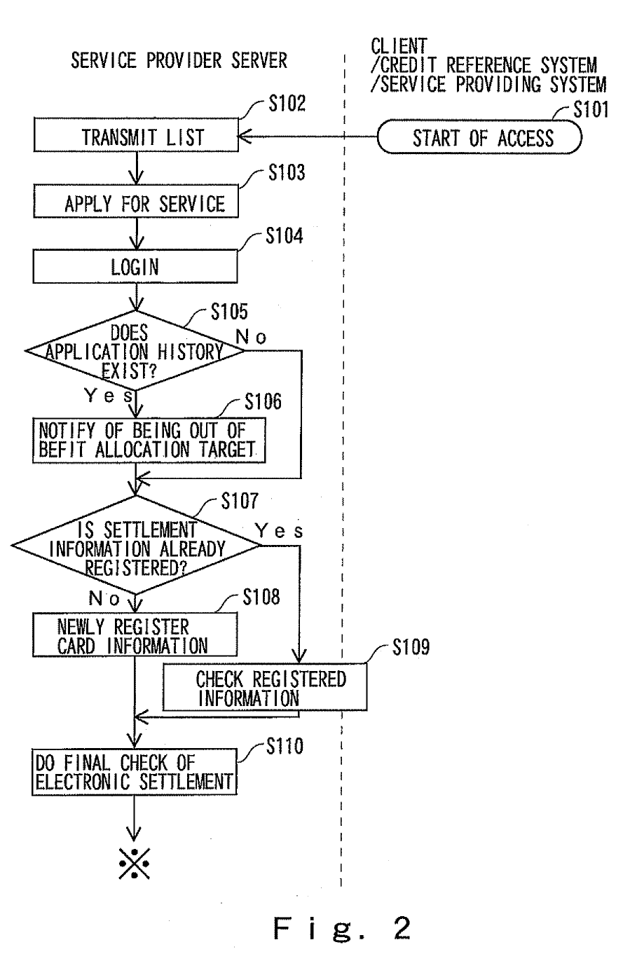

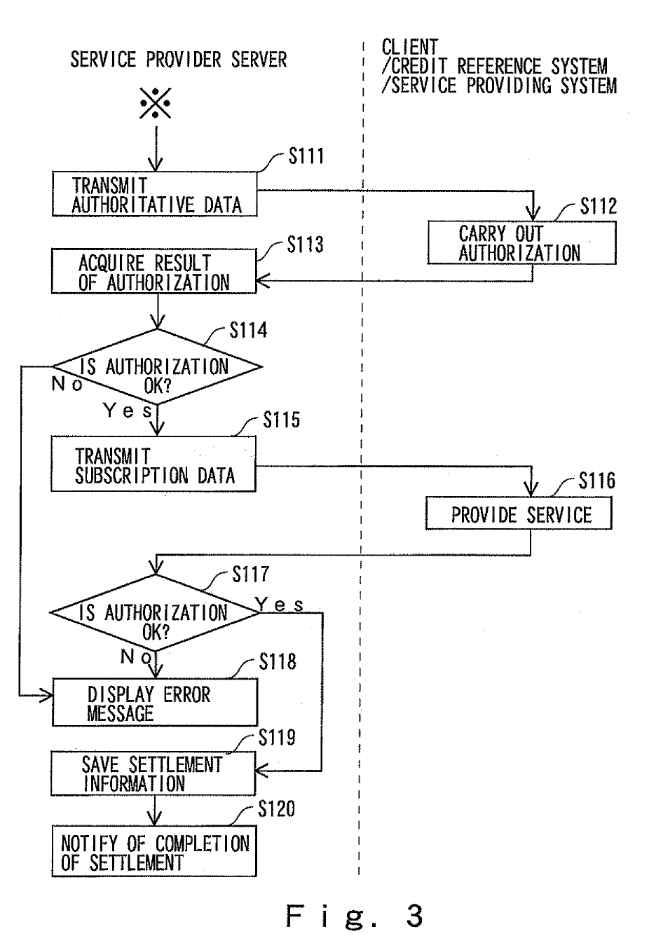

FIGS. 2 and 3 are flowcharts each showing a processing flow of the service provider server 1 according to the present embodiment. The processing flow of the service provider server 1 will herein after be described with reference to the flowcharts in FIGS. 2 and 3.

The client 3 accesses, based on the command given from the user, a service list screen of the service provider server 1 (S101). The client 3 searches for the service provider server 1 connected to the Internet on the basis of a URL (Uniform Resource Locator) inputted to an address bar of the Web Browser and establishes the communication line.

The service provider server 1, upon receiving the access from the client 3, transmits the information on the contents etc of the monthly payment system services to the client 3 (S102). The client 3 displays a list of the monthly payment system services transmitted from the service provider server 1 on the display. The list of the monthly payment system services displayed on the display of the client 3 is so displayed as to be selectable by a manipulation of a mouse etc, and a scheme is that the user clicks on a button of a desired service, thereby enabling the application for the service to be made.

The service provider server 1, when receiving the request for providing the monthly payment system service from the client 3 (S103), requests the client 3 for the login ID, the password, etc (S104). The service provider server 1 collates the login ID and the password transmitted from the client 3 with the databased items of information stored in the DB-A11, and checks whether or not the transmitted login ID and password are coincident with the databased items of information. The service provider server 1, if the login ID and the password transmitted from the client 3 are coincident with the databased items of information stored in the DB-A11, authenticates the login of the client 3, and proceeds with the service application procedures. Whereas if the login ID and the password are not coincident with the databased items of information stored in the DB-A11, the service provider server 1 rejects the login of the client 3 and interrupts the service application procedures.

The service provider server 1 checks whether or not the monthly payment system service with the charge-free benefit requested by the client 3 kept in the login is a service having a record that the client 3 made the application in the past (S105). Namely, the service provider server 1, when receiving the service providing request from the client 3, searches the databased information stored in the DB-A11 and refers to a history of the services utilized in the past by the client 3.

Herein, such a case is considered that the client 3 might log in by use of a user ID different from the user ID employed when utilizing the services in the past. Namely, this is a case where the client 3 separately obtains a new user ID in order to pretend a new user and then logs in. Such being the case, the service provider server 1 according to the present embodiment, for preventing the same client pretending the different user from being provided with the same service, refers to contents of the services utilized in the past by the client 3 by use of the credit card number employed in the past by the client 3 in addition to the user ID and the password.

Generally, as for the credit card, issuance of the card involves making a credit search about the user and carrying out a strict examination. Therefore, when the service provider server specifies the user, it is easier to detect the user who pretends a different user by specifying the user with the credit card number issued via the credit search than by specifying the user by employing the user ID and the mail address. There is widespread of the service of issuing the mail addresses on a charge-free basis, thereby enabling the same user to easily acquire a multiplicity of mail addresses. Therefore, if the user thinks that he or she is provided with the same service dually, it follows that the user can be provided with the service dually by using the multiplicity of mail addresses. While on the other hand, the credit card is issued after a credit card issuance company has inquired into user's identity and after the user has undergone the examination. Hence, even if the same user thinks that he or she is provided with the service dually, it is difficult to immediately acquire the multiplicity of credit card numbers. Therefore, when the service provider server specifies the user, it is feasible by using the credit card to eliminate the case that the malicious user is provided with the service dually.

The service provider server 1, if the monthly payment system service requested by the client 3 is a service having the history that the client 3 made the application in the past, notifies the client 3 of alarm information (S106). The alarm information of which the service provider server 1 notifies the client 3 has a content purporting that the client 3 can not be provided with the service including the benefit (e.g., the service that is free of a monthly membership fee for the first month, and so on) given to the service.

While on the other hand, the service provider server 1, if the monthly payment system service requested by the client 3 is a service having none of the history that the client 3 made the application in the past, moves to a step (S107) of checking the settlement information etc (S105).

Note that the service provider server 1, in S105, if there is a new access from the client 3 and if the credit card number used in the past by the client 3 is not recorded in the database DB-B12 (if none of the application history is retrieved), determines that there is no service for which the client 3 applied in the past, and moves to a step (S107) for checking the settlement information etc (S105).

The service provider server 1 checks the settlement information (S107). To be specific, the service provider server 1 refers to the databased items of information stored in the database DB-B12, thus checking whether the items of settlement information such as the credit card number and the personal identification number needed for the client 3 to carry out the electronic settlement, are registered therein or not.

The service provider server 1, if the settlement information of the client 3 is not registered in the DB-B12, requests the client 3 to newly register the credit card number (S108). Namely, the service provider server 1 gets anew input screen for the settlement information required for performing the electronic settlement displayed on the display of the client 3, and prompts the user to input the settlement information such as the credit card number and the personal identification number. The service provider server 1, upon receiving the settlement information sent from the client 3, stores these items of settlement information in the database DB-B12 in a way that associates these items of information with the user ID, and moves to a next step (S110).

On the other hand, the service provider server 1, if the settlement information of the client 3 is registered in the DB-B12, gets the settlement information within the DB-B12 displayed on the display of the client 3 (S109), and moves to a next step (S110).

The service provider server 1 displays, on the display of the client 3, a screen for finally checking whether or not the electronic settlement may be executed based on the settlement information inputted in S108 or the settlement information displayed in S109, and prompts the user to do the final check of the electronic settlement (S110). The service provider server 1, when receiving from the client 3 the information purporting that the electronic settlement may be executed, moves to a next step (S111).

The service provider server 1, upon receiving an approval of executing the electronic settlement by the user, transmits the settlement information (authoritative data) such as the credit card number, a name and a price of the purchased commercial article to the credit reference system 5 (S111). Note that the service provider server 1, if the service requested by the client 3 to be provided is a service with a charge-free benefit for a fixed period of time, sets an amount billed, which is transmitted to the credit reference system 5, to an amount of money that is as small as 1 yen, and there after transmits the settlement information. Namely, in the case of providing the benefit service, though originally unnecessary for conducting the electronic settlement by transmitting the data to the credit reference system 5, the service provider server 1 according to the present embodiment, for performing the credit search of the client 3, takes a way of carrying out the credit search by taking the trouble to transmit the data of the settlement information to the credit reference system 5 even in the case of the charge-free service. Note that the company operating the service provider server 1 takes a burden without charging the user for a cost of using the credit card, which thereby occurs.

The credit reference system 5, when receiving the settlement information transmitted from the service provider server 1, refers to the database retained by the credit reference system 5 itself, and determines whether the electronic settlement can be done or not (S112). The credit reference system 5, when determining that the settlement information transmitted from the service provider server 1 satisfies the requirements (such as the maximum available amount etc of the credit card) enabling the electronic settlement be done, transmits to the service provider server 1 the information purporting that the electronic settlement has been approved. While on the other hand. The credit reference system 5, when determining that the settlement information transmitted from the service provider server 1 does not satisfy the requirements enabling the electronic settlement to be done, transmits to the service provider server 1 the information purporting that the electronic settlement is not approved.

The service provider server 1 obtains a result of the approval of the electronic settlement from the credit reference system 5 (S113). The service provider server 1, when receiving the information purporting that the electronic settlement is approved, moves to a step (S115) for providing the service (S114). While on the other hand, the service provider server 1, when receiving the information purporting that the electronic settlement is not approved, transmits this information purporting that the electronic settlement is not approved to the client 3 and gets this information displayed on the display.

The service provider server 1, when acquiring the approval of the electronic settlement from the credit reference system 5, transmits subscription data (a service providing instruction signal) to the service providing system 4 (S115). The subscription data contains contents of the service to be provided, service providing starting date and time, service providing ending date and time, and a name and an address of the client 3 to which the service should be provided. It is to be noted that the service provider server 1 may transmit the subscription data directly to the service providing system 4, and the subscription data may also be sent via a relay system etc that undertakes batchwise service allocations to the plurality of service providing systems 4.

The service providing system 4 provides the service to the client 3 along the information of the subscription data transmitted from the service provider server 1. With this scheme, the client 3 can receive the variety of services.

<Storage Medium Readable by Computer>

A program for making a computer, other machines, devices (which will herein after be referred to as the computer etc) actualize any one of the functions given above can be recorded on a recording medium readable by the computer etc. Then, the computer etc is made to read and execute the program on this recording medium, whereby the function can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those demountable from the computer etc.

Further, a hard disc, a ROM (Read-Only Memory), etc are given as the recording mediums fixed within the computer etc.

What is claimed is:

1. A service provider server comprising:
a service providing unit providing a service to a client via a communication network;
a condition setting storage unit having a setting of a predetermined condition required to be satisfied when said client is provided with a charge-free service;
a card number storage unit stored with credit card number data transmitted from said client via the communication network; and
a service history storage unit stored with a history of the charge-free service provided to said client,
wherein said service providing unit, when receiving a fee-charging service providing request from said client, transmits the credit card number data transmitted from said client, with which the fee-charging service providing request accompanies, to a credit reference system and, when receiving a result of approval from said credit reference system, provides the fee-charging service and stores the credit card number data in said card number storage unit,
said service providing unit, when receiving a charge-free service providing request from said client, searches said card number storage unit for existence or non-existence of data coincident with the credit card number data transmitted from said client, with which the charge-free service providing request accompanies, and further searches said service history storage unit for existence or non-existence of a history of the charge-free service provided to said client, and
said service providing unit, if the charge-free service providing request of said client satisfies the predetermined condition, provides the charge-free service and stores a charge-free service providing history in said service history storage unit.

2. A service provider server according to claim 1, wherein the predetermined condition is a condition that the charge-free service is not provided if data coincident with the credit card number data transmitted from said client, with which the charge-free service providing request accompanies, is retrieved by searching said card number storage unit and if the history of providing the charge-free service to said client is retrieved by searching said service history storage unit.

3. A service providing method for providing a service provided by a service provider server comprising:
a service providing unit providing a service to a client via a communication network;
a condition setting storage unit having a setting of a predetermined condition required to be satisfied when said client is provided with a charge-free service;
a card number storage unit stored with credit card number data transmitted from said client via the communication network; and
a service history storage unit stored with a history of the charge-free service provided to said client,
wherein said service providing unit, when receiving a fee-charging service providing request from said client, transmits the credit card number data transmitted from said client, with which the fee-charging service providing request accompanies, to a credit reference system and, when receiving a result of approval from said credit reference system, provides the fee-charging service and stores the credit card number data in said card number storage unit,
said service providing unit, when receiving a charge-free service providing request from said client, searches said card number storage unit for existence or non-existence of data coincident with the credit card number data transmitted from said client, with which the charge-free service providing request accompanies, and further searches said service history storage unit for existence or non-existence of a history of the charge-free service provided to said client, and
said service providing unit, if the charge-free service providing request of said client satisfies the predetermined condition, provides the charge-free service and stores a charge-free service providing history in said service history storage unit.

4. A service providing method according to claim 3, wherein the predetermined condition is a condition that the charge-free service is not provided if data coincident with the credit card number data transmitted from said client, with which the charge-free service providing request accompanies, is retrieved by searching said card number storage unit and if the history of providing the charge-free service to said client is retrieved by searching said service history storage unit.

5. A recording medium recorded with a service providing program for making a service provider server provide a service, said server comprising:
a service providing unit providing a service to a client via a communication network;
a condition setting storage unit having a setting of a predetermined condition required to be satisfied when said client is provided with a charge-free service;
a card number storage unit stored with credit card number data transmitted from said client via the communication network; and
a service history storage unit stored with a history of the charge-free service provided to said client,
wherein said service provider server makes said service providing unit execute, when receiving a fee-charging service providing request from said client, transmitting the credit card number data transmitted from said client, with which the fee-charging service providing request accompanies, to a credit reference system and, when receiving a result of approval from said credit reference system, providing the fee-charging service and storing the credit card number data in said card number storage unit,
said service provider server makes said service providing unit execute, when receiving a charge-free service providing request from said client, searching said card number storage unit for existence or non-existence of data coincident with the credit card number data transmitted from said client, with which the charge-free service providing request accompanies, and further searching said service history storage unit for existence or non-existence of a history of the charge-free service provided to said client, and
said service provider server makes said service providing unit execute, if the charge-free service providing request of said client satisfies the predetermined condition, providing the charge-free service and storing a charge-free service providing history in said service history storage unit.

6. A recording medium recorded with a service providing program according to claim 5, wherein the predetermined condition is a condition that the charge-free service is not provided if data coincident with the credit card number data transmitted from said client, with which the charge-free service providing request accompanies, is retrieved by searching said card number storage unit and if the history of providing the charge-free service to said client is retrieved by searching said service history storage unit.
